(19) United States
(12) Patent Application Publication
(10) Pub. No.: US 2013/0121696 A1
(43) Pub. Date: May 16, 2013

(54) APPARATUS AND METHOD FOR PHOTONIC NETWORKS

(71) Applicants: Daniele Ceccarelli, Genova (IT); Diego Caviglia, Savona (IT); Paolo Rebella, Bergeggi (IT)

(72) Inventors: Daniele Ceccarelli, Genova (IT); Diego Caviglia, Savona (IT); Paolo Rebella, Bergeggi (IT)

(73) Assignee: Telefonaktiebolaget L M Ericsson (publ), Stockholm (SE)

(21) Appl. No.: 13/378,417

(22) PCT Filed: Jul. 11, 2011
(86) PCT No.: PCT/EP11/61730

§ 371 Date: Oct. 23, 2012

(51) Int. Cl. H04B 10/27

(52) U.S. Cl. CPC H04B 10/27
USPC 398/58

(57) ABSTRACT

A node for use in a photonic network comprises an optical to electrical interface for receiving a traffic signal and an electrical to optical interface for outputting a traffic signal. A processor is adapted, in response to receiving a control plane message, to reconfigure at least one feature of an optical-to-electrical-to-optical conversion process carried out in the node, according to a type of traffic signal identified by the control plane message.

### TECHNICAL FIELD

The invention relates to an apparatus and method for photonic networks, for example a wavelength switched optical network (WSON).

### BACKGROUND

Dynamic photonic networks are becoming increasingly more common due to the availability of optical switching technology such as Wavelength Selective Switch (WSS).

FIG. 1 shows a photonic or optical network comprising a node A1 which is configured to transmit a traffic signal to node A4 along a first working path 1, via nodes A2 and A3. FIG. 1 also shows a node B1 configured to transmit a traffic signal to node B4 along a second working path 3, via nodes B2 and B3.

In photonic networks lambda switching (or wavelength switching) is the technology used to switch individual wavelengths of light onto separate paths for specific routing of information. Each lambda can carry different types of client traffic, having different rates, different modulation formats, and so on.

For example, in FIG. 1 a traffic signal from node A1 to A4 may be configured to transport 40 Gbps labeled switched path (LSP) traffic, while the traffic signal from node B1 to B4 may be configured to transport 10 Gbps LSP traffic.

Nodes D1, D2 and D3 of FIG. 1 illustrate a protection path 5 for the first working path 1, with node D2 being a regeneration node, also known as a 3R node. If a node on the working path fails, for example if node A2 fails, then node A1 can still transmit its 40 Gbps traffic signal to node A4 via nodes D1, D2 and D3, i.e. via the protection path 5.

A disadvantage of photonic networks is that resources, such as 3R regenerators, cannot be shared among server layers (lambda) carrying different types of client traffic, such as Ethernet, LAN-PHY, SDH, Fiber Channel. This is because the 3R regenerators are configured to only handle a particular type of client traffic. This inability to share resources is particularly disadvantageous where resources are expensive to implement.

As such, if node B2 were to fail in the working path 3, then node B1 cannot send traffic to node B4 via nodes D1, D2 and D3. This is because the nodes D1, D2, D3 are configured to operate as a protection path 5 for nodes A1, A2, A3 and A4, which operate at 40 Gbps in the example, which means that nodes D1, D2 and D3 cannot handle the 10 Gbps traffic signal of nodes B1, B2, B3 and B4.

The photonic network shown in FIG. 1 therefore has the disadvantage in that transit nodes that perform optical-electrical-optical (OEO) regeneration cannot be shared among photonic paths that carry different client traffic signals, even if they have the same modulation format. In a scenario where automatic rerouting is implemented, for example when using protection path switching, this means that regenerators cannot be shared, since they are unable to carry different types of traffic when a rerouting procedure is performed.

### SUMMARY

It is an aim of the present invention to provide a method and apparatus for a photonic network that overcomes or reduces one or more of the disadvantages mentioned above.

According to a first aspect of the invention there is provided a node for use in a photonic network. The node comprises an optical to electrical interface for receiving a traffic signal, and an electrical to optical interface for outputting a traffic signal. The node comprises a processor adapted, in response to receiving a control plane message, to reconfigure at least one feature of an optical-to-electrical-to-optical conversion process carried out in the node according to a type of traffic signal identified by the control plane message.

The invention has the advantage of enabling a node to be reconfigured to suit different types of traffic signals, which in turn has the advantage of enabling expensive resources such as 3R regenerators to be shared in a network.

According to another aspect of the invention there is provided a method in a node of a photonic network. The method comprises the steps of receiving a traffic signal at an optical to electrical interface, and receiving a control plane message. At least one feature of an optical-to-electrical-to-optical process carried out within the node is reconfigured, based on a type of traffic signal identified by the control plane message. The traffic signal is transmitted via an electrical to optical interface.

According to another aspect of the invention there is provided a control plane message for use in a photonic network. The control plane message comprises information for identifying at least the type of traffic signal being transported in the photonic network, wherein the control plane message is used by an optical-to-electrical-to-optical node of the photonic network, for dynamically reconfiguring the operation of the optical-to-electrical-to-optical node according to the type of traffic signal being transported.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a basic photonic network;

FIG. 2 shows a node for use in a photonic network, according to an embodiment of the present invention;

FIG. 3 shows the format of a label switched path, LSP, attributes object according to the Internet Engineering Task Force (IETF) recommendation RFC 5420;

FIG. 4 shows the format of an attributes type-length-value, TLV, data structure;

FIG. 5 shows the format of a type-length-value, TLV, data structure according to an embodiment of the present invention;

FIG. 6 shows the steps performed by an embodiment of the present invention;

FIG. 7 shows a photonic network according to an embodiment of the present invention; and

FIG. 8 shows further details of a node of a photonic network, according to an embodiment of the present invention.

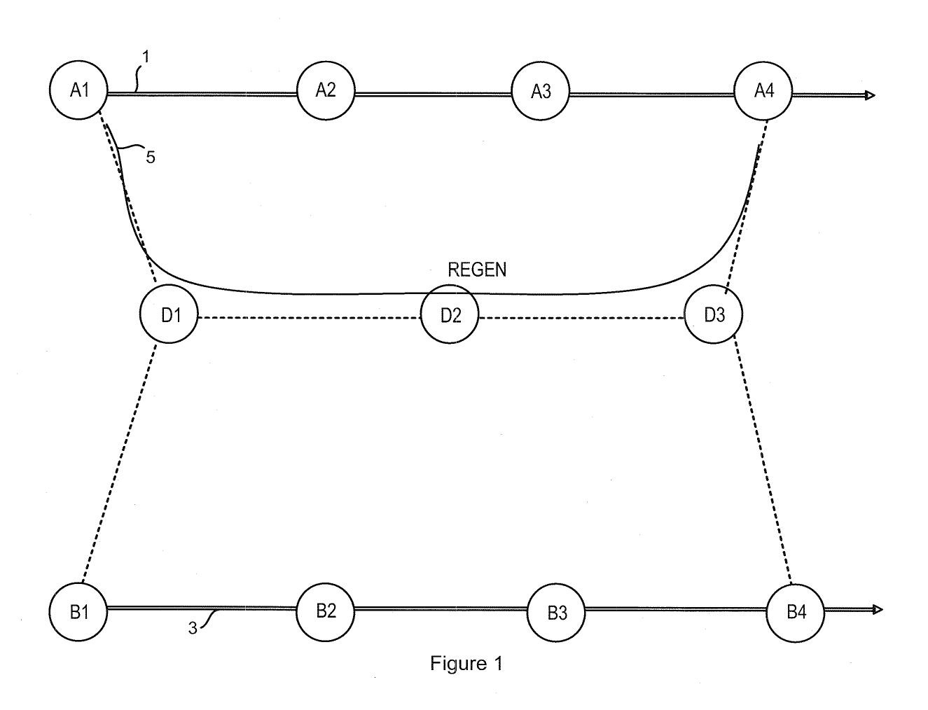

### DETAILED DESCRIPTION

Embodiments of the present invention described below enable resources to be shared among different server layers (lambda) carrying different types of client traffic. This is made possible by adapting resources, such as regenerators, such that they are dynamically reconfigurable for different types of client traffic. The regenerators are made reconfigurable by providing a control plane message, for example an enhanced switching protocol, that is adapted to identify the type of client traffic being transmitted.

The shared resources include, but are not limited to, resources such as 3R regenerators, which are expensive resources in an optical network.

The embodiments described below enable a node in an optical network such as a wavelength switched optical network, to know what each lambda is carrying, for example what kind of Optical Transport Network (OTN) client is being carried, the rate of the traffic signal, the modulation format of the traffic signal, and so on, and dynamically reconfigure a node accordingly.

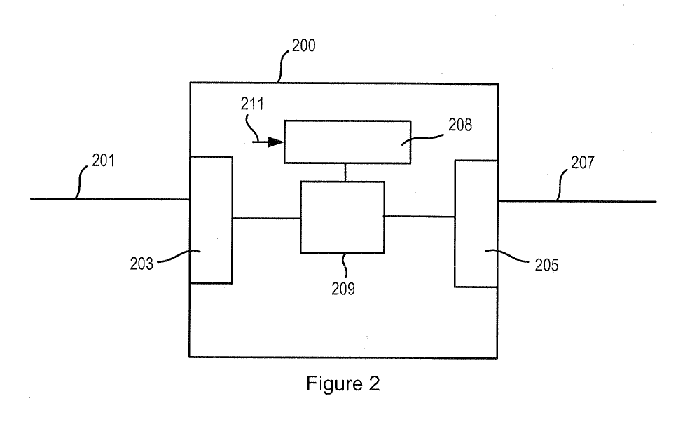

FIG. 2 shows a node 200 for use in a photonic network, according to an embodiment of the present invention. The node comprises an optical to electrical interface 203 for receiving a traffic signal 201. The node also comprises an electrical to optical interface 205 for outputting a traffic signal 207. A processor 208 is adapted, in response to receiving a control plane message 211, to reconfigure at least one feature of an optical-to-electrical-to-optical conversion process 209 carried out in the node 200, according to a type of traffic signal identified by the control plane message 211.

In a scenario where automatic rerouting is implemented, this means that shared regenerators can be reconfigured so as to be able to carry different types of traffic every time that a rerouting procedure is performed.

The control plane message 211 may comprise an in-band message which is received with, or within, the traffic signal 201. Alternatively, the control plane message 211 may comprise an out-band message which is received from a management or control network, not shown. The control plane message 211 may therefore be received from the optical to electrical interface 203 together with the traffic, or from a management interface (not shown). A management interface is an interface not used for client traffic, and which can be used by a control plane (control network) or a management plane (management network). Such a management interface is commonly used by the management plane, and can be used by the control plane as a backup resource in the event that the traffic interfaces are not available. As such, the control plane message 211 may be received from another node upstream of the node 200, or from a management or control network.

According to embodiments of the invention, the control plane message may comprise a control plane massage of the Generalized Multi Protocol Label Switching (GMPLS) protocol suite being developed by the Internet Engineering Task Force (IETF). The application of GMPLS to photonic networks is called Wavelength Switched Optical Network (WSON). It is noted, however, that the invention is not limited to a control plane message for GMPLS, and may be used with other control plane mechanisms.

According to one embodiment, the control plane message is implemented as a protocol extension in the form of a new type of Type-Length-Value (TLV) data structure defined in a Resource Reservation Protocol-Traffic Engineering, RSVP-TE, protocol.

The new sub-TLV data structure is introduced into the LSP_ATTRIBUTES object of the RSVP-TE (defined in RFC5420). The LSP_ATTRIBUTES object is used to signal attributes required in support of a label switched path, LSP, or to indicate the nature or use of an LSP where that information is not required to be acted on by all transit label switching routers, LSRs. Traditionally, if an LSR does not support an object, it forwards it unexamined and unchanged. This facilitates the exchange of attributes across legacy networks that do not support this new object.

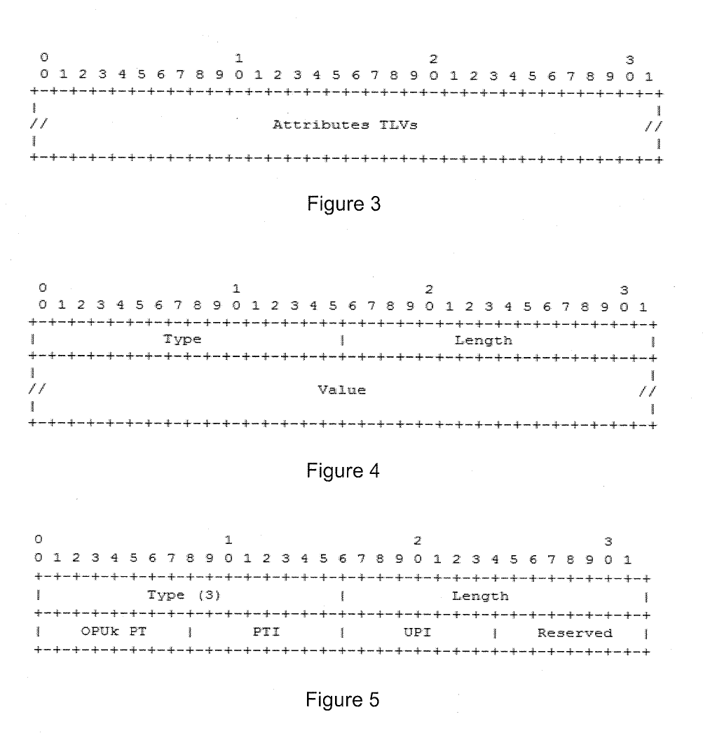

FIG. 3 shows the format of an existing LSP_ATTRIBUTES object, which has a class number equal to 197, and a C-type=1, as defined by Internet Engineering Task Force paper RFC5420.

Attributes carried by the LSP_ATTRIBUTES object are encoded within TLVs. One or more TLVs may be present in each object. There are no ordering rules for TLVs, and they are encoded as shown in FIG. 4.

The “Type” field is the identifier of the TLV. Type 1 and Type 2 are already defined in the RSVP-TE protocol.

The “Length” field is used to indicate the total length of the TLV in octets. That is, the combined length of the Type, Length, and Value fields, i.e. four plus the length of the Value field in octets.

The “Value” field contains the data carried in the TLV.

FIG. 5 shows a new type of TLV data structure according to an embodiment of the present invention, referred to hereinafter as “Payload Type TLV (Type=3)”. It will be appreciated that the type=3 is only used as a reference, and any number could be assigned or adopted for this TLV in the RFC recommendations or standards.

The TLV contains one or more data fields, the one or more data fields comprising information for identifying at least one characteristic of a traffic signal being transmitted or transported in the photonic network.

A first data field “OPUk PT” relates to the optical channel payload unit (OPUk), and is defined by ITU-T G.709 recommendation (Table 15-8) and is a code point identifying the type of optical payload unit (OPU) being carried.

The second data field “PTI” comprises a Payload Type Identifier, which may be a vendor specific code point identifying one or more characteristics of the traffic signal type identified by the first data field above. For example, the payload type identifier may comprise rate information, modulation format, or other features of the traffic signal type being carried. The PTI can be analyzed at end points of the label switched path, LSP, and/or at the transit nodes, for example where regeneration is performed (such as optical-electrical-optical, OEO, conversion). As a vendor specific field, this enables each vendor to provide whatever information they might require in this particular data field.

The third data field “UPI” comprises a User Payload Identifier, and is a code point defined in ITU-T 6.7041 and is used to identify the type of payload conveyed in the generic framing procedure, GFP, payload information field. Table 1 below shows an example of PTI values referring to 10 Gbps LSPs that may be used in a node of an optical network.

| PTI | Client traffic description | |
|---|---|---|
| 38 | 9.95328 | Gbit/s (no frame monitoring)# |
| 46 | 10.3125 | Gbit/s (Gigabit Ethernet LAN/PHY)+ |
| 47 | 9.95328 | Gbit/s ODU2 Multiplex |
| 63 | 10.51875 | Gbit/s (Fibre Channel) |

The “Reserved” data field may be reserved for future extensions.

In the example of FIG. 5 the OPUk PT, PTI and UPI data fields are each shown as comprising 8 bits. However, it is noted that the number of bits used to represent each data field can differ from the values shown in FIG. 5, without departing from the scope of the invention. Furthermore, although FIG. 5 shows the code points OPUk PT and UPI being used to identify the type of OPU and payload being carried, it is noted that other code points may be used in different applications and different embodiments of the invention.

The new TLV data structure enables the type of traffic signal, its characteristics, and the type of payload to be identified, such that nodes in the optical network can be dynamically reconfigured to handle any payload type.

The TLV data structure of FIG. 5 includes the data that may be used by nodes in the optical network to enable them to be reconfigurable, such as photonic Label Switched Path (LSP) end nodes, and transit nodes such as 3R regenerators (Optical-Electrical-Optical conversion with signal regeneration). This data enables such network nodes to correctly manage the client traffic being carried.

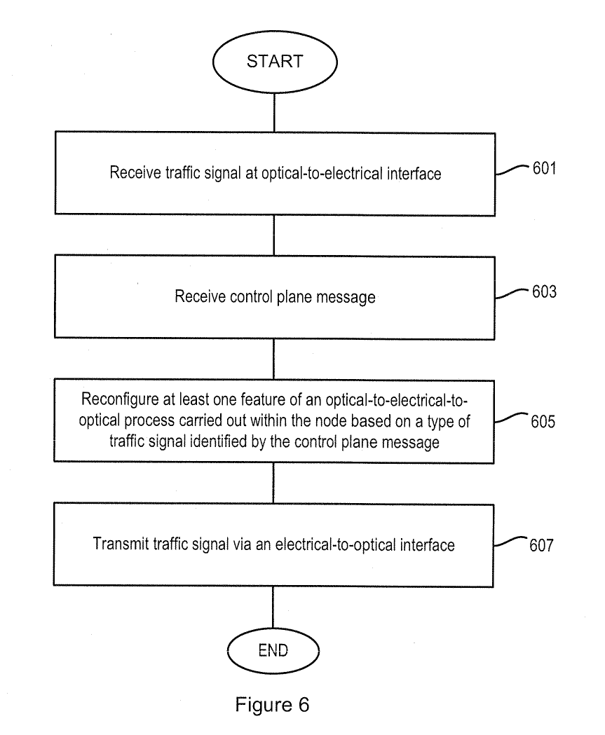

FIG. 6 shows a method performed by an embodiment of the invention. In step 601a traffic signal is received at an optical to electrical interface. In step 603 a control plane message is received. At least one feature of an optical-to-electrical-to-optical process carried out within the node is reconfigured, step 605, based on a type of traffic signal identified by the control plane message. The traffic signal is transmitted via an electrical to optical interface, step 607.

As mentioned above, the control plane message may comprise a type-length-value (TLV) data structure that comprises one or more data fields, for example as shown in FIG. 5, comprising information for identifying at least one characteristic of a traffic signal being transported. The information provided in the control plane message is used to dynamically reconfigure a node in the photonic network.

Adding this feature to the signaling protocol allows for nodes or resources to be shared, such as Optical-Electrical-Optical (OEO) regenerators (which tend to be the most expensive resources of a photonic network) among a set of protected LSPs carrying different types of client traffic (for example, Ethernet, Fiber Channel, LAN/PHY, SDH). Without this kind of information it would only be possible to share those OEO regenerators among LSPs carrying the same type of client traffic, (e.g. SDH).

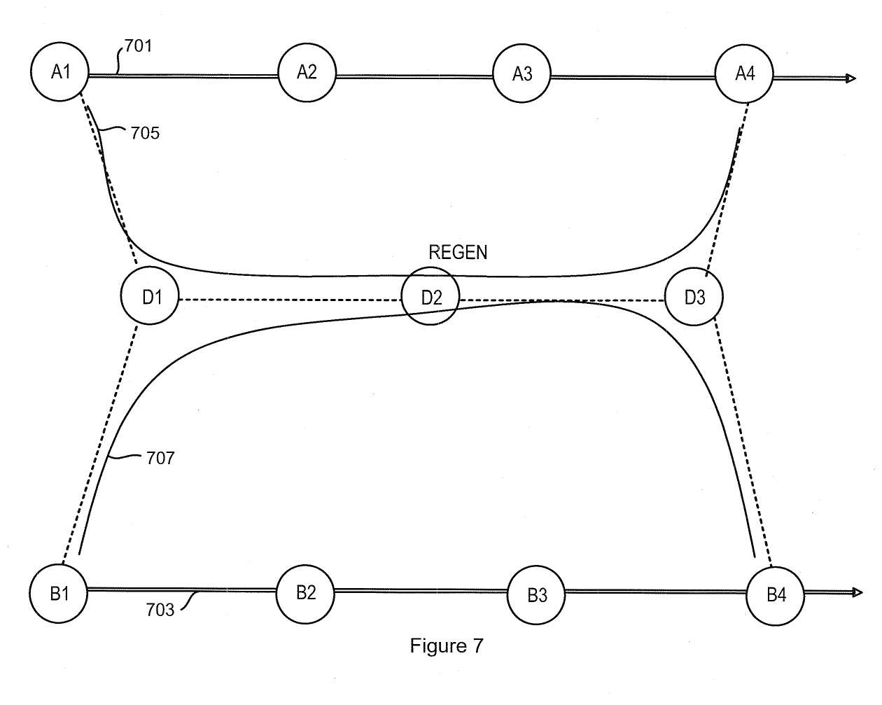

For example, in FIG. 7 a traffic signal from node A1 to A4 may be configured to transport 40 Gbps labeled switched path (LSP) traffic on a working path 701, for example, while the traffic signal from node B1 to B4 may be configured to transport 10 Gbps LSP traffic on a working path 703.

Nodes D1, D2 and D3 of FIG. 7 illustrate a protection path 705 for the first working path 701, with node D2 being a regeneration node, also known as a 3R node. If node A2 fails, then node A1 can still transmit its 40 Gbps traffic signal to node A4 via nodes D1, D2 and D3, i.e. via the protection path 705.

According to embodiments of the present invention, if node B2 were to fail, then node B1 can still transport traffic to node B4 via nodes D1, D2 and D3. This is because the regeneration node D2 can be reconfigured to operate as a protection path 707 for nodes B1, B2, B3 and B4. In response to receiving a control plane message, the regeneration node D2 can be reconfigured such that the optical-to-electrical-to-optical conversion process carried out by node D2 is adapted to handle the 10 Gbps traffic signal of nodes B1, B2, B3 and B4.

As mentioned above, the control plane message received by node D2 may be received as an in-band control message with the traffic signal itself, or as an out-band control message from a control network. Therefore, as mentioned above, the control plane message may be received from a management or control interface, or from an optical to electric interface with a traffic signal.

A processor in the node D2 may be adapted to return an error message in the event that the processor is unable to reconfigure the node D2 to handle the identified type of traffic signal. The error message may be returned to the node from which the traffic signal was received, or to the management or control network. The node D2 can be configured to return the error message via the same interface that was used to receive the control plane message. Alternatively, the error message may be returned via a different interface to that used for receiving the control plane message. In one embodiment, control plane messages for reconfiguring the node are sent before the traffic is sent, so that they configure the regenerator before the traffic is sent. Alternatively, the control plane messages can be sent with the traffic signal, and the node reconfigured on-the-fly. A check on the configurability of a node may be performed before sending a control plane message to a node, for example when the capabilities of the nodes are periodically advertised by the routing protocol.

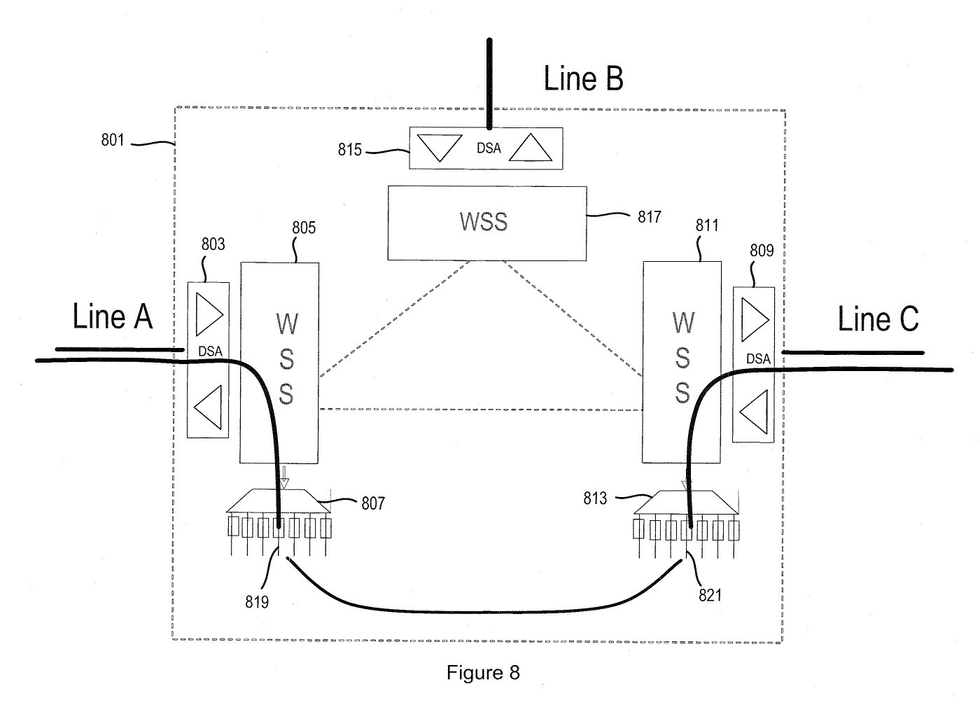

FIG. 8 shows further details of a network node 801 according to another embodiment of the present invention. The node 801 is shown as connecting traffic between Line A and Line C. When transporting a traffic signal from Line A to Line C, the traffic signal is received at an optical to electrical interface comprising a receiver 803, wavelength selective switching (WSS) device 805 and a bank of transponders (transponder 819 being shown as selected in the example). An electrical to optical interface is provided for outputting the traffic signal to Line C, and comprises a bank of transponders (821 being shown as selected in the example), a WSS device 811 and a transmitter 809. It will be appreciated that the optical to electrical interface 803, 805, 807, 819 may also operate as an electrical to optical interface when traffic is being transported in the opposite direction, i.e. from Line C to Line A, such that the unit 803 comprises an optical receiver and transmitter. The same will be applicable to the electrical to optical interface 821, 813, 811, 809 when operating in a bi-directional mode of operation.

The traffic signal received from Line A is processed by a wavelength selective switching (WSS) device 805, with the optical signal being converted into an electrical signal by one of the plurality of transponders, for example transponder 819. The electrical signal between transponder 819 and transponder 821 may be processed to enhance the signal in some way, for example, during the regeneration of the traffic signal (not shown). The electrical signal is then converted into an optical signal by transponder 821, and passed via the WSS device 811 and transmitter 809 to Line C.

According to an embodiment of the invention the node 801 can be reconfigured, in response to receiving a control plane message (not shown), to handle different types of traffic signals between the lines connected to the node 801.

The embodiments of the invention have the advantage of providing signaling extensions that enable the dynamic reconfiguring of resources such as 3R regenerators, so as to be able to be used for lambdas carrying any type of client traffic. This allows sharing the same regenerator pools among a high number of circuits along the network, thus providing a significant cost saving.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A node for use in a photonic network, the node comprising:
an optical to electrical interface for receiving a traffic signal;
an electrical to optical interface for outputting a traffic signal;
and
a processor adapted, in response to receiving a control plane message, to reconfigure at least one feature of an optical-to-electrical-to-optical conversion process carried out in the node according to a type of traffic signal identified by the control plane message.

2. A node as claimed in claim 1, wherein the control plane message is provided in a type-length-value (TLV) data structure, the TLV data structure comprising one or more data fields, the one or more data fields comprising information for identifying at least one characteristic of the traffic signal being transported in the photonic network.

3. A node as defined in claim 2, wherein the processor is adapted to:
identify the traffic signal type from a first data field in the TLV data structure;
identify at least one characteristic of the traffic signal type identified by the first data field, using a second data field of the TLV data structure; and
identify the type of payload conveyed in the traffic signal using a third data field.

4. A node as claimed in claim 3, wherein the first data field comprises an optical channel payload unit (OPUk PT) identifier, for identifying the type of optical payload unit (OPU) being transported.

5. A node as claimed in claim 3, wherein the second data field comprises a payload type identifier (PTI), providing information relating to at least one of rate information or modulation format information of the traffic signal being transported.

6. A node as claimed in claim 3, wherein the third data field comprises a user payload identifier (UPI), providing information relating to the type of payload conveyed in the traffic signal.

7. A node as claimed in claim 1, wherein the control plane message is transported with the traffic signal.

8. A node as claimed in claim 1, wherein the control plane message is received from a control network.

9. A node as claimed in claim 1, wherein the processor is further adapted to return an error message, in the event that the processor is unable to reconfigure the node to handle the identified type of traffic signal.

10. A method in a node of a photonic network, the method comprising the steps of:
receiving a traffic signal at an optical to electrical interface;
receiving a control plane message;
reconfiguring at least one feature of an optical-to-electrical-to-optical process carried out within the node, based on a type of traffic signal identified by the control plane message; and
transmitting the traffic signal via an electrical to optical interface.

11. A method as claimed in claim 10, wherein the reconfiguring step comprises the steps of:
identifying the traffic signal type using a first data field in the control plane message;
identifying at least one characteristic of the traffic signal type identified by the first data field, using a second data field of the control plane message; and
identifying the type of payload conveyed in the traffic signal using a third data field of the control plane message.

12. A method as claimed in claim 11, wherein the first data field comprises an optical channel payload unit (OPUk PT) identifier, for identifying the type of optical payload unit (OPU) being transported.

13. A method as claimed in claim 11, wherein the second data field comprises a payload type identifier (PTI), providing information relating to at least one of rate information or modulation format information of the traffic signal being transported.

14. A method as claimed in claim 11, wherein the third data field comprises a user payload identifier (UPI), providing information relating to the type of payload conveyed in the traffic signal.

15. A method as claimed in claim 10, wherein the control plane message comprises a type-length-value (TLV) data structure.

16. A control plane message for use in a photonic network, wherein the control plane message comprises information for identifying at least the type of traffic signal being transported in the photonic network, wherein the control plane message is used by an optical-to-electrical-to-optical node of the photonic network, for dynamically reconfiguring the operation of the optical-to-electrical-to-optical node according to the type of traffic signal being transported.

17. A control message as claimed in claim 16, wherein control plane message comprises a type-length-value data structure, the type-length-value data structure comprising:
a first data field for identifying the traffic signal type being transported;
a second data field for indicating at least one characteristic of the traffic signal type identified by the first data field; and
a third data field for identifying the type of payload conveyed in the traffic signal.

18. A control message as claimed in claim 17, wherein the first data field comprises an optical channel payload unit (OPUk PT) identifier, for identifying the type of optical payload unit (OPU) being transported.

19. A control message as claimed in claim 17, wherein the second data field comprises a payload type identifier (PTI), providing information relating to at least one of rate information or modulation format information of the traffic signal being transported.

20. A control message as claimed in claim 17, wherein the third data field comprises a user payload identifier (UPI), providing information relating to the type of payload conveyed in the traffic signal.
